(19) United States
(12) Patent Application Publication
(10) Pub. No.: US 2007/0015125 A1
(43) Pub. Date: Jan. 18, 2007

(54) Automated updating of job assessments

(75) Inventors: Tommie A. Mobbs, San Antonio, TX (US); Juan E. Benavidez, San Antonio, TX (US); James P. Robinson III, San Antonio, TX (US); Bruce C. Richardson JR., San Antonio, TX (US)

Correspondence Address: WOODCOCK WASHBURN LLP, ONE LIBERTY PLACE, 46TH FLOOR, 1650 MARKET STREET, PHILADELPHIA, PA, 19103, US

(73) Assignee: Presidio Sciences, L.P., San Antonio, TX (US)

(21) Appl. No.: 11/268,256

(22) Filed: Nov. 7, 2005

Related U.S. Application Data
(63) Continuation-in-part of application No. 11/204,800, filed on Aug. 16, 2005.
(60) Provisional application No. 60/699,099, filed on Jul. 14, 2005.

(51) Int. Cl. G09B 19/00

(52) U.S. Cl. 434/219

(57) ABSTRACT

The results of a performance appraisal are correlated with data collected from a job assessment process. Questions from the assessment that relate to high employee performance, and low employee performance are desirably identified. Questions that have no relation to performance are also desirably identified, as well as any additional questions such as those that show gender, age, or racial bias, for example. For those questions that are shown to predict high or low performance, the relative weights of those questions in the job assessment can be adjusted upwards so that they will have a greater bearing on whether an employee is hired. Those questions that show little or no relation to employee performance can be weighted downward, or removed entirely, resulting in a more streamlined and efficient job assessment process.

### CROSS REFERENCE TO RELATED APPLICATIONS

This application is a continuation-in-part of U.S. patent application Ser. No. 11/204,800, filed Aug. 16, 2005, entitled “AUTOMATED UPDATING OF JOB ANALYSES” which claims the benefit of U.S. Provisional Patent Application No. 60/699,099, filed Jul. 14, 2005, each of which is hereby incorporated by reference in its entirety.

### BACKGROUND

A job assessment is a process used to identify candidates for a job. The job assessment process is an integral component of a company's workforce management system. The job assessment process typically comprises several phases, starting with an initial pre-screening phase where job candidates are screened based on certain minimum characteristics, and ending with one or more in-person interviews, for example. While many employers typically spend a great deal of time and money engineering an initial job assessment process, few take the time to review the effectiveness of their job assessment process once implemented. This failure may be a result of the lack of proper integration of the job assessment process into other components of the workforce management system, such as the performance appraisal process. Because it may be difficult to link performance appraisal data for a particular employee with assessment data collected for that employee, the effectiveness of the assessment process cannot be accurately measured. In addition, even if the assessment data can be linked with the appraisal data, there may be no procedure in place to make the necessary changes in the assessment process based on the performance data. Failure to review the effectiveness of the job assessment process can result in repeated hiring of poor performing employees, failure to recognize potential high performing candidates, or illegal discriminated hiring

Therefore, what are needed are systems and methods for automatically updating the job assessment process.

### SUMMARY

The following summary provides an overview of various aspects of the invention. It is not intended to provide an exhaustive description of all of the important aspects of the invention, nor to define the scope of the invention. Rather, this summary is intended to serve as an introduction to the detailed description and figures that follow.

A job assessment process is developed. The job assessment process may be a component of a workforce management system. Employees are hired according to the job assessment process. After some period of time, a performance appraisal is performed on the employees hired to perform the job. The results of the performance appraisal are correlated with the data collected during the assessment process. Questions from the assessment that have a relationship with high employee performance, and low employee performance are desirably identified. Questions that have no relation to performance are also desirably identified, as well as any additional questions such as those that show gender, age, or racial bias, for example. For those questions that are shown to predict high or low performance, the relative weights of those questions in the assessment can be adjusted upwards so that they will have a greater bearing on whether an employee is hired. Those questions that show little or no relation to employee performance can be weighted downward, or removed entirely, resulting in a more streamlined and efficient job assessment process. Similarly, questions that show gender, age, or racial bias, for example, can be removed to avoid the appearance of a biased job assessment system.

Additional features and advantages of the invention will be made apparent from the following detailed description of illustrative embodiments that proceeds with reference to the accompanying drawings.

### BRIEF DESCRIPTION OF THE DRAWINGS

The foregoing summary, as well as the following detailed description of preferred embodiments, is better understood when read in conjunction with the appended drawings. For the purpose of illustrating the invention, there is shown in the drawings exemplary constructions of the invention; however, the invention is not limited to the specific methods and instrumentalities disclosed. In the drawings:

FIG. 1 is a diagram of an exemplary workforce management system in accordance with the present invention;

FIG. 2 is a flow diagram illustrating an exemplary method for updating a job analysis in accordance with the present invention;

FIG. 3 is a flow diagram illustrating an exemplary method of updating a job assessment in accordance with the present invention; and

FIG. 4 is a block diagram showing an exemplary computing environment in which aspects of the invention may be implemented; and

FIG. 5 is a block diagram showing an exemplary networking environment in which aspects of the invention may be implemented.

### DETAILED DESCRIPTION

The subject matter is described with specificity to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the term “step” may be used herein to connote different elements of methods employed, the term should not be interpreted as implying any particular order among or between various steps herein disclosed unless and except when the order of individual steps is explicitly described.

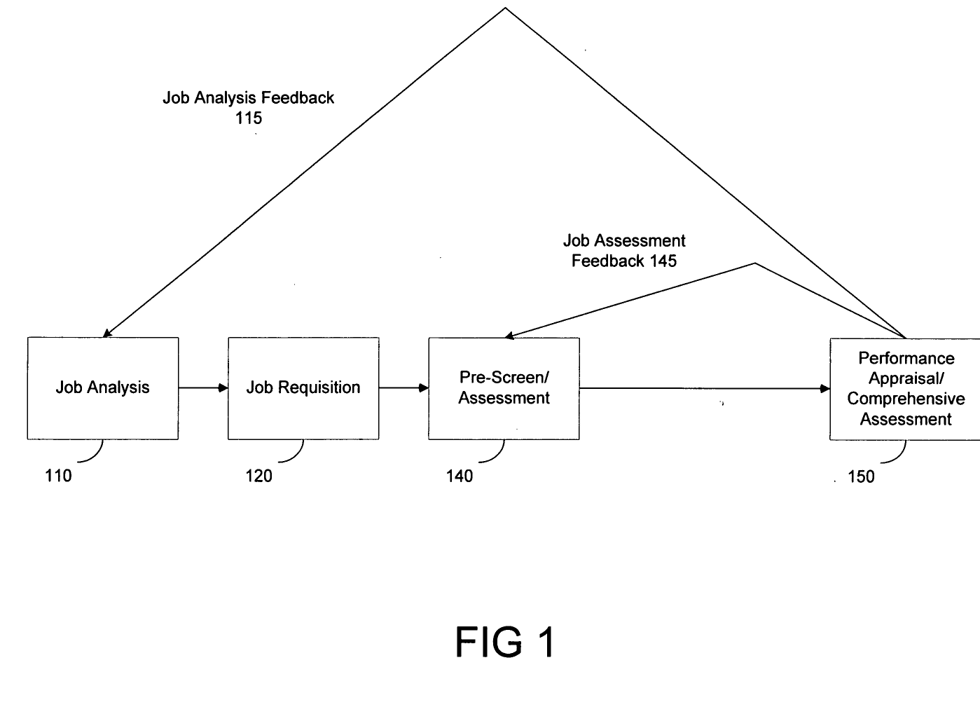

FIG. 1 is a diagram of an exemplary workforce management system in accordance with the present invention. The system comprises several stages or steps including a job analysis development step 110, a job requisition step 120, a pre-screen/assessment step 140, and a performance appraisal/comprehensive assessment step 150. In addition, the system desirably comprises a job analysis feedback loop 115, whereby the existing job analysis, and related requisition and pre-screen/assessment steps, can be updated to better reflect information discovered or otherwise determined during the performance appraisal/comprehensive assessment step 150. Similarly, the system may also comprise a job assessment feedback loop 145 where the particular questions or tests administered during the pre-screen/assessment step 140 may also be updated based on data collected during the performance appraisal/comprehensive assessment step 150, or other information such as voluntary turnover, absences or terminations, for example.

At 110, one or more job analyses are desirably created. A job analysis may be created through a process of determining knowledges, skills, abilities (“KSAs”), interests, and general work activities (“GWAs”), and/or behaviors, etc. that are desirable, useful, or necessary for performing a particular job. This information can be used in a variety of ways including generating job descriptions, determining salaries, and evaluating employee performance, for example.

The job analysis may be initially based on the U.S. Department of Labor's Employment and Training Administration's Occupational Information Network (“O*Net”). O*Net comprises a database of GWAs and KSAs for certain typical jobs. Because O*Net descriptions are based on a wide variety of companies and industries, the GWAs and KSAs stored for a particular job may differ from the GWAs and KSAs actually required or desired for the particular job as specified by an employer. Therefore, it may be desirable to supplement the data in O*Net for a particular job, with data collected by or for the company relating to the job being analyzed. Although examples herein are described using O*Net, it is contemplated that any job description repository, public or private, may be used alone or in conjunction with other repositories, such as O*Net. The repository may comprise a database, a memory, or any other storage device.

To facilitate the creation of the job analysis, a job survey or questionnaire may be administered to subject matter experts (“SMEs”). SMEs are those in a company or organization who are familiar with the particular job being analyzed. These may include job incumbents, supervisors, or administrators. The questionnaire may be administered using a computer application such as a web browser, for example. The questionnaire may be based on the KSAs and GWAs listed in O*Net or another job description database or memory. The resulting job analysis may be generated by modifying the particular KSAs and GWAs as listed in the database based on the results of the questionnaires. The job analysis may be created by a consultant, or automatically by a computer based on the questionnaire. Once created, the job analysis is desirably stored e.g., for use in the creation of the workforce management system.

For example, a company specializing in the sale of food products to restaurants may have a job analysis created for a salesman. To facilitate this, a consultant hired to create the job analysis may first consult O*Net or another database or memory to determine what KSAs and GWAs are recommended for a salesman. Recognizing that the actual KSAs and GWAs for the job may differ significantly from those listed in O*Net, the consultant may design a questionnaire for SMEs familiar with the salesman job. The questionnaire is desirably designed to determine which of the KSAs and GWAs listed in O*Net are relevant to the job, and what additional KSAs or GWAs not listed in O*Net may also be required or desired. Alternatively, the consultant may observe a salesman at the job in order to determine desirable KSAs and GWAs.

At 120, the generated job analysis may be used for job requisition purposes. As described above, the generated job analysis desirably includes GWAs and KSAs that may be necessary or desirable for the performance of the job. Using the job analysis as a base, a user such as a human resources person or consultant may generate a job description for the particular job. The job description may be entered into a database, memory, or storage device using a web browser, for example. Alternatively, the job description may be generated automatically by a computer using the KSAs and GWAs comprised in the generated job analysis.

Once the job description has been generated, the job description may be distributed according to the policies of the particular organization. For example, a company might require that a particular job position be made available internally for one month before being made available to the general public. Other companies may have particular partner publications or web sites where they desire the job description to be published. A human resourses personnel or other administrator or user may specify how the job requisition process should function using a computer application, such as a web browser, for example. Alternatively, the details of the job requisition process may be determined by an expert or consultant after evaluating the particular needs or desires of a company, for example.

At 140, potential job candidates are desirably screened and assessed according to the generated job analysis. The assessment process may comprise one or more steps or phases, depending on the needs of the particular company or organization. However, a particular organization may require more or fewer phases than those described below. There is no minimum or maximum number of phases required for the job assessment.

For example, the assessment process may comprise a first pre-screening phase. This phase may comprise an initial questionnaire that may be administered in person, over the telephone, or over the Internet, for example. The pre-screening phase may be used to determine if a candidate meets certain minimum qualifications for the job. These minimum qualifications are desirably determined using the generated job analysis, for example. The contents of the pre-screening phase may be determined by a consultant or specialist, or may be generated automatically using the job analysis and template questions. Any system, method, or technique known in the art may be used.

For example, a candidate for a brick layer job may be presented with a questionnaire designed to determine if the candidate meets the minimum qualifications for a brick layer as defined by the job analysis. The candidate may be asked if he or she can lift more than 60 pounds, or if the candidate can stand for a long period of time, for example. Depending on how the candidate answers the questions, the candidate may proceed to a further screening phase.

After passing the initial pre-screening phase, the candidate may move on through one or more additional phases designed to further eliminate the less suitable candidates. The applicants may be presented with an additional questionnaire designed to measure additional KSAs or GWAs from the generated job analysis. For example, the candidate may be asked questions designed to measure bio-data, such as how much experience the applicant has. The questions may also attempt to measure qualities such as personality and integrity, for example.

Candidates passing the further phase questionnaires may be subject to an interview. The interview may be a structured interview, generated automatically from the KSAs and GWAs comprised in the job analysis, for example. Once a candidate has completed all of the stages of the assessment process, the candidate may be hired to perform the specified job.

At 150, a performance appraisal and comprehensive assessment is desirably performed. The performance appraisal is used to evaluate the performance of one or more employees performing a particular job. The evaluation of employee performance may occur at any time or frequency desired by an organization or employer. The desired time or frequency of performance appraisals may be specified by an administrator using a web browser, for example. The performance appraisal is desirably designed to measure and evaluate the particular KSAs and GWAs identified by the generated job analysis. In contrast, the comprehensive assessment measures particular KSAs and GWAs not identified in the original job analysis. By measuring one or more KSAs and GWAs not identified in the original job assessment, new relevant KSAs and GWAs may be indentified.

The performance appraisal may comprise a combination of objective measured performance metrics, e.g., sales quotas, and subjective evaluations, e.g., Behavior Anchored Rating Scales (BARS). The actual weight given to the objective and subjective portions of the appraisal may be determined by an administrator and may depend on several factors such as company policy and the specific job being appraised. The comprehensive assessment may comprise a similar measure of the one or more KSAs and GWAs not part of the original pre-screen and assessment process.

For example, after a predetermined time has elapsed, or when desired by a supervisor or administrator, an employee may be evaluated. To facilitate the process, one or more administrators familiar with the employee may be presented with a questionnaire. The questionnaire may have been designed by a consultant or administrator using the job analysis, or may have been directly generated automatically by a computer, for example.

The questionnaire may comprise one or more questions directed to KSAs and GWAs identified in the initial job analysis. The questions may be based on the BARS system and may take the form of a statement and ask the administrator to specify if they agree or disagree with the statement using a rating system or scale, such as, e.g., a five or seven point rating scale. For example, a statement might read “the employee always puts his or her tools in their proper place.” The statement may then be followed by a five point rating scale where a one may correspond to high disagreement with a statement, and a five may correspond to high agreement with the statement. The user or administrator may then select the number corresponding to their relative agreement with the statement.

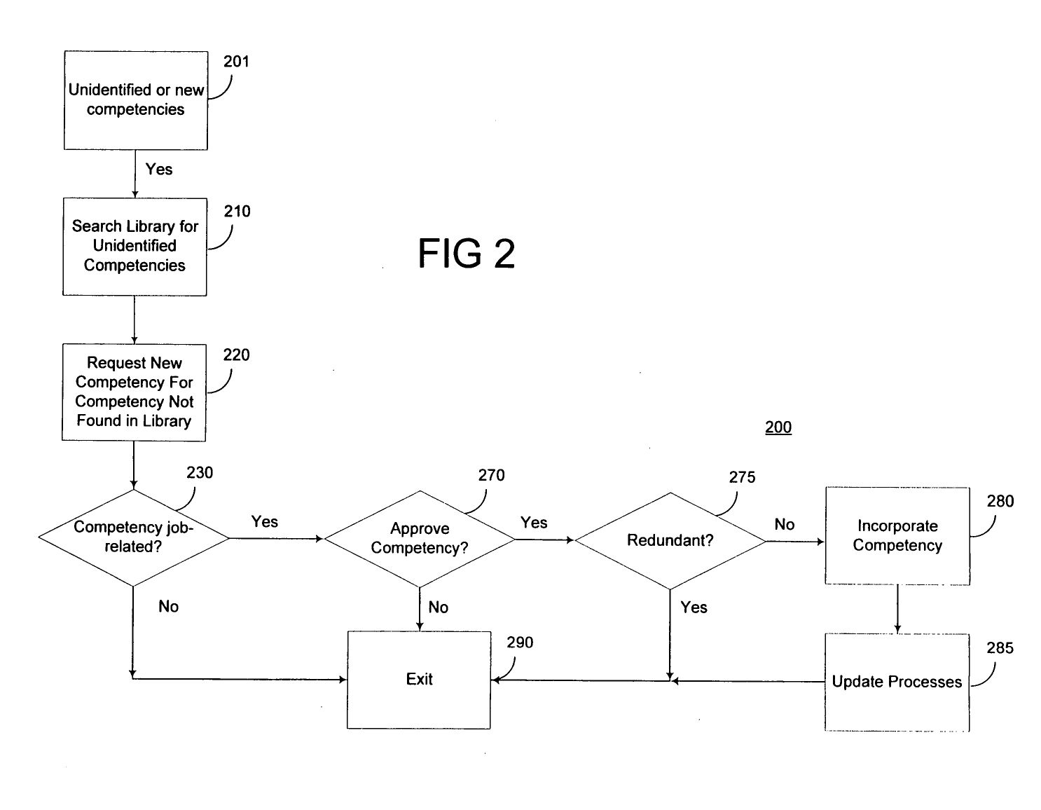

In addition, the user or administrator may be asked to identify or specify if this employee has any additional KSAs or GWAs that may make him or her well suited for the job, but that may not have been identified in the job analysis. For example, the administrator may have noted that the employee's math skills make him or her a better bricklayer than the other employees. These unidentified KSAs and GWAs may be submitted for approval and used to update or modify the existing job analysis in the job analysis feedback loop 115, as described further with respect to FIG. 2.

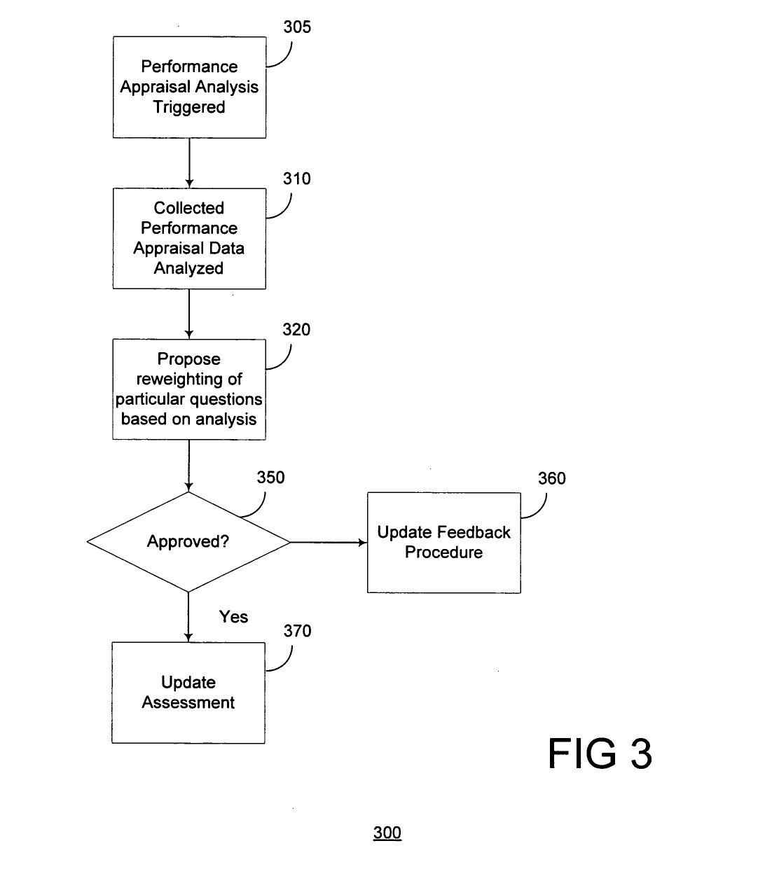

After a predetermined number of performance appraisals and comprehensive assessments for a particular job have been conducted, the collected data may be compared with the pre-screen/assessment data collected for that particular employee at 140. The performance results and the assessment data are compared to determine if there were any particular questions asked during the assessment phase that may have predicted the performance of this employee. The resulting data can be analyzed across some or all of the employees performing the particular job, to determine which questions are good predictors of performance, and which questions are performance neutral. The assessment process may then be updated to emphasize those questions that predict performance and deemphasize those questions that are performance neutral. Similarly, the assessment data may be related to other job related data, such as data on absenteeism and job turnover for example, to determine if there are any particular questions that predict these behaviors. Likewise, the measures in the comprehensive assessment can be analyzed with respect to their relationship with job performance. This will aid in the identification of competencies that may be important for superior job performance, but were not identified in the original job analysis. This job assessment feedback system is described further with respect to FIG. 3, for example.

FIG. 2 is a flow diagram illustrating an exemplary method for incorporating unidentified competencies into an existing job analysis. An unidentified competency is identified. The competency is optionally presented to a user such as an SME or human resources personnel for review. If the competency is approved, then the competency is desirably incorporated into the existing job analysis. Further, any job requisition systems, assessment systems, or appraisal systems based on the updated job analysis may be updated to reflect the new competency.

At 201, it is determined that there are newly identified competencies for a particular job or jobs. A competency may include KSAs and GWAs, for example. As described above, during the course of a performance appraisal or comprehensive assessment for a particular job, there may be newly identified competencies not part of the original KSAs and GWAs identified in the initial job analysis for the job. For example, it may be recognized that a previously unrecognized skill or other characteristic is beneficial to the performance of a job. This characteristic may be recognized by an SME or administrator during the course of a job assessment, for example.

In addition, after a merger or restructuring of a corporate department it may be desirable that certain jobs be expanded or combined with other existing jobs. For example, in the case where the additional duties of a first job are merged with the duties of a second job, it may be desirable to revise the job analysis of the second job to include the additional competencies required by the first job.

At 210, a library is desirably searched for the newly identified competencies. As described previously, the library may comprise a database of jobs and job related KSAs and GWAs. Initially, the library may be populated using O*Net, or any similar database. However, as the library is updated to include newly identified KSAs and GWAs, the library may become particularly tailored to a specific user, company, or job analysis consultant, for example.

The library may be searched by a user (e.g., an administrator or a consultant) using a computer application such as a web browser. Because the competencies may be identified by observation, and without the exact terminology used by the library in mind, a user is desirably presented with the most relevant library entries matching the user's search. The user may be permitted to search the library using a variety of methods, including a natural language search. Any system, method, or technique known in the art for searching data may be used.

After viewing the results, the user may then select the result that best matches the newly identified competency.

At 220, if the user was not satisfied with the competencies returned from the library, the user may request a new entry in the library to capture the competency. The new competency may be generated by SMEs or incumbents identified as superior performers of the particular job. Alternatively, consultants may be hired to generate the competency, for example.

At 230, the newly identified competency may be presented to SMEs, or other users familiar with the job, to measure the perceived importance or job-relatedness of the newly identified competency. The SMEs may be presented with a questionnaire that asks them to rate the unidentified competency using a variety of question types. The results of the questionnaire may then be analyzed across all participating SMEs to determine if the newly identified competency is deemed to have a high enough importance or high enough job-relatedness to be added to the job analysis.

For example, a particular SME may recognize that employees who have good personal hygiene make better bricklayers. However, before adding a hygiene competency to the job analysis, it may be desirable to first present the competency to other SMEs or administrators to determine how they feel about the competency, and whether they believe that it would be beneficial to add it to the job analysis. Accordingly, the SMEs may be presented with a questionnaire designed to measure their opinions of the new competency. Any system, method, or technique known in the art may be used.

If the competency is found desirable by the SMEs, then the process may continue at 270 for further review. Else, the competency is not desirable and it may be discarded at 290.

At 270, the new competency may be reviewed by a human resources personnel. In some cases a company may desire that proposed competencies be reviewed by human resources before adding them to a job analysis. For example, the company may desire to review the competency to make sure that it does not violate a company policy, or that while the competency may be desirable, requiring such a competency may severely limit the pool of applicants for the particular job. If a particular competency is approved then it may be checked for redundancy at 275. Else, the competency may be discarded and the process may exit at 290.

At 275, the new competency may be checked for redundancy with respect to the existing job analysis. As the competency library grows, many of the competencies may become somewhat redundant of one another. For example, one job may require that an employee move 50 pounds, while another job may require that the employee lift 50 pounds. While having these separate, but similar, competencies in the same competency library is desirable because they are subtlety different, it may not be desirable to have such similar competencies as part of the same job analysis.

Consequently, the new competency is compared with the existing competencies in the job analysis to determine if the new competency has too much overlap with, or is redundant of, another competency already in the job analysis. The new competency may be compared with the existing competencies automatically, based on a statistical analysis for example. If the new competency matches an existing competency with a confidence level greater than a predefined threshold, 90% for example, then the competency is desirably discarded. Otherwise, the competency is desirably found to be not redundant. Alternatively, the relative redundancy may be judged by a consultant or SME, for example.

If the competency is found to be redundant the process may exit at 290. Else, the competency is not redundant and the process may continue at 280.

At 280, the competency has been approved and may be added to the existing job analysis and the competency library. In addition, related job requisition, assessment, and appraisal procedures may have to be developed for the newly added competency. For example, if the competency was not found in the library of competencies, there may be no interview questions associated with the competency to use in the assessment process. Similarly, there may be no job description type information to use in the requisition process. Accordingly, administrators or SMEs may develop the desired questions or procedures related to the new competency for use in generating the job requisition, assessment, and appraisal procedures for the updated job analysis. Alternatively, consultants may generate the desired or necessary data from the new competency. Any system, method, or technique may be used.

At 285, the processes based on the job analyses may be updated or regenerated. As described previously, a job requisition process, an applicant assessment process, and a performance appraisal process were desirably generated using a job analysis. In order to ensure that these processes still accurately reflect the underlying job, the processes are desirably updated, or regenerated, using the updated job analysis. The processes may be updated automatically by a computer, for example, or the company may use a consultant or other expert to make the updates.

FIG. 3 is a flow diagram of an exemplary job assessment feedback procedure in accordance with the present invention. A performance appraisal is performed on current employees performing a particular job. The results of the performance appraisal are analyzed or compared with the results of a pre-hire employee assessment process, including employee questionnaires. Questions from the assessment that relate to high employee performance, and low employee performance are desirably identified. Questions that have no relation to performance are also desirably identified, as well as any additional questions such as those that show gender, age, or racial bias, for example). For those questions that are shown to predict high or low performance, the relative weights of those questions in the employee assessment can be adjusted upwards, either empirically or rationally, so that they will have a greater bearing on whether an employee is hired. Those questions that show little or no relation to employee performance can be weighted downward, or removed entirely, resulting in a more streamlined and efficient employee assessment process. Similarly, questions that show gender, age, or racial bias, for example, can be removed to avoid the appearance of a biased employee assessment system.

At 305, the analysis of collected performance appraisal data for a particular job is desirably triggered. The analysis of the collected performance data may be triggered by a user defined event. For example, when the number of collected performance evaluations for a particular job reaches a certain number or threshold, the performance analysis may be triggered. The particular threshold or number of collected evaluations needed to trigger an analysis may be determined by an administrator or consultant, for example. The threshold value may be selected based on the desire for accuracy (i.e., a high number of evaluations) versus the desire to quickly determine if a particular assessment procedure is effective (i.e., a low number of evaluations). In addition, the relative size of the company or job position may also be considered when determining the threshold. Any system, method, or technique known in the art may be used to determine the appropriate threshold.

The performance data, in addition to the metrics collected in the performance appraisals, may comprise additional work related data. For example, the performance data may include measured employee efficiency data, employee absences, and employee sick days. There is no limit to the types of employment data that may be considered.

At 310, collected performance appraisal data for a job is desirably analyzed against the assessment process data for that job. The performance appraisal data desirably is taken in part from the performance appraisals such as those described with respect to FIG. 1. The performance appraisals may comprise several questions related to the specific KSAs and GWAs corresponding to the job being evaluated. In addition, the performance appraisals may test attributes that are not directly related to the KSAs or GWAs, but may be desired as part of an overall corporate policy. For example, a corporation may desire that its employees show a commitment to the community through participation in charity events.

The analysis of the job assessment process may be performed by correlating the answers of the particular questions asked of candidates with the ultimate performance of those candidates as measured by the performance appraisals. The correlation method is one method that may be used to determine if there are any questions, or aspects of the assessment process for this job, that either predicts good performance, bad performance, or has no association with job performance. How high the correlation should be between a particular question and performance before it is considered to be significant is up to the user or administrator of the system. However, any statistical system, method, or technique known in the art can be used to determine the degree of relationship between predictors and criteria.

For example, a ‘yes’ answer for a particular question may be found to predict high performance 80% of the time. This question has a high correlation with high performance. A ‘no’ answer for another question may predict bad performance 90% of the time. This question has a high correlation with low performance. Another question may be shown to be associated with high performance 50% of the time, and low performance 50% of the time. This question has a low correlation with both high performance and low performance.

In addition, a company may wish to determine which questions of the job assessment phase are gender, sex, or racially biased, for example. A question may be biased if a particular answer to the question can be correlated with a member of a protected group or class. Eliminating such questions can protect a company from accusations that their hiring process is biased, for example.

At 320, a modification or re-weighting of the assessment phase questions and procedures is proposed. During the assessment process, employees are asked a series of questions. Each question may have a weight based on its importance to the hiring process. Therefore, it is desirable that questions that predict high performance be accorded a higher weight. Accordingly, the proposed modifications may re-weigh the questions based on their calculated correlation with performance. Questions shown to have a high correlation with performance may have their relative weighting increased. Questions shown to have a low correlation with performance may have their relative weight decreased. In addition, it may be proposed that questions be removed if it is shown that they have a very low correlation with performance. Removing such questions from the assessment process helps make the process as efficient as possible.

Similarly, questions shown to be biased against a protected class may be removed or re-weighted.

At 350, the proposed modifications may be presented for a review. The review may be conducted by human resources personnel or an administrator, for example. While not necessary, the review may be desirable to ensure that proposed modifications do not conflict with company policy.

For example, a company may desire that all of its employees be good citizens and participate in community service projects. However, it may be shown through the analysis process that having a high commitment to the community does not mean that a candidate will be a top performing employee. However, a company may still desire such an attribute for reasons such as community relations, for example. Accordingly, if it is proposed that questions related to community service be weighted lower, the human resources personnel may reject it.

The questions may be presented in categories for human resources approval. For example, those questions with a high level of correlation with performance may be presented in a “very good” category, meaning that they may be weighted higher. Similarly, those questions that have a low or medium relationship with performance may be presented in either a “good” or “fair” category, meaning that they may be weighted slightly lower or higher. In addition, those questions shown to be biased towards a protected class may be flagged by presenting them in a group called “do not use.” The questions and categories may be presented to the human resources department using a webpage, or other computer based system. Any system, method, or technique known in the art may be used.

If a proposed modification to the assessment process is approved, then the assessment process may be updated at 370. Otherwise, the modification was rejected and the process may continue to 360, where the job assessment feedback process may be updated to reflect the rejection by the human resources personnel. The feedback process is desirably updated to ensure that a similar assessment modification will not be proposed again.

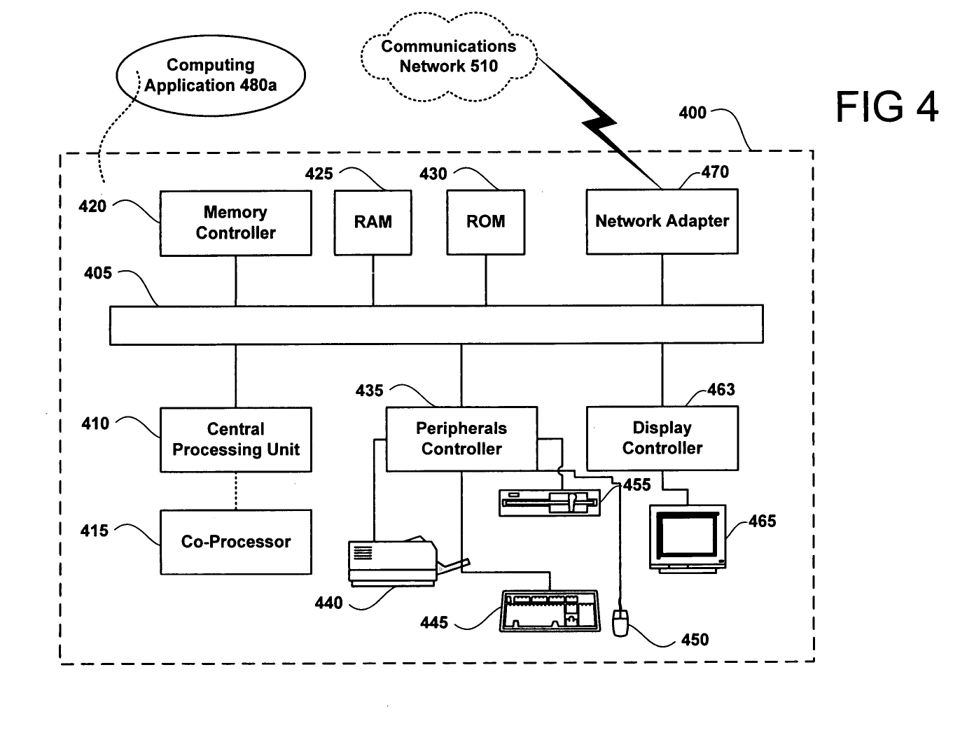

FIG. 4 depicts an exemplary computing system 400 capable of implementing a workforce management system in accordance with the invention. Computing system 400 executes an exemplary computing application 480a. Exemplary computing system 400 is controlled primarily by computer-readable instructions, which may be in the form of software, wherever, or by whatever means such software is stored or accessed. Such software may be executed within central processing unit (CPU) 410 to cause data processing system 400 to do work. In many known workstations and personal computers, central processing unit 410 is implemented by a single-chip CPU called a microprocessor. Coprocessor 415 is an optional processor, distinct from main CPU 410, that performs additional functions or assists CPU 410. One common type of coprocessor is the floating-point coprocessor, also called a numeric or math coprocessor, which is designed to perform numeric calculations faster and better than a general-purpose CPU 410. Recently, however, the functions of many coprocessors have been incorporated into more powerful single-chip microprocessors.

In operation, CPU 410 fetches, decodes, and executes instructions, and transfers information to and from other resources via the computer's main data-transfer path, system bus 405. Such a system bus connects the components in computing system 400 and defines the medium for data exchange. System bus 405 typically includes data lines for sending data, address lines for sending addresses, and control lines for sending interrupts and for operating the system bus. An example of such a system bus is the PCI (Peripheral Component Interconnect) bus. Some of today's advanced busses provide a function called bus arbitration that regulates access to the bus by extension cards, controllers, and CPU 410. Devices that attach to these busses and arbitrate to take over the bus are called bus masters. Bus master support also allows multiprocessor configurations of the busses to be created by the addition of bus master adapters containing a processor and its support chips.

Memory devices coupled to system bus 405 include random access memory (RAM) 425 and read only memory (ROM) 430. Such memories include circuitry that allow information to be stored and retrieved. ROMs 430 generally contain stored data that cannot be modified. Data stored in RAM 425 can be read or changed by CPU 410 or other hardware devices. Access to RAM 425 and/or ROM 430 may be controlled by memory controller 420. Memory controller 420 may provide an address translation function that translates virtual addresses into physical addresses as instructions are executed. Memory controller 420 also may provide a memory protection function that isolates processes within the system and isolates system processes from user processes. Thus, a program running in user mode can access only memory mapped by its own process virtual address space; it cannot access memory within another process's virtual address space unless memory sharing between the processes has been set up.

In addition, computing system 400 may contain peripherals controller 435 responsible for communicating instructions from CPU 410 to peripherals, such as, printer 440, keyboard 445, mouse 450, and disk drive 455.

Display 465, which is controlled by display controller 463, is used to display visual output generated by computing system 400. Such visual output may include text, graphics, animated graphics, and video. Display 465 may be implemented with a CRT-based video display, an LCD-based flat-panel display, gas plasma-based flat-panel display, or a touch-panel. Display controller 463 includes electronic components required to generate a video signal that is sent to display 465.

Further, computing system 400 may contain network adapter 470 which may be used to connect computing system 400 to an external communication network 510. Communications network 510 may provide computer users with means of communicating and transferring software and information electronically. Additionally, communications network 510 may provide distributed processing, which involves several computers and the sharing of workloads or cooperative efforts in performing a task. It will be appreciated that the network connections shown are exemplary and other means of establishing a communications link between the computers may be used.

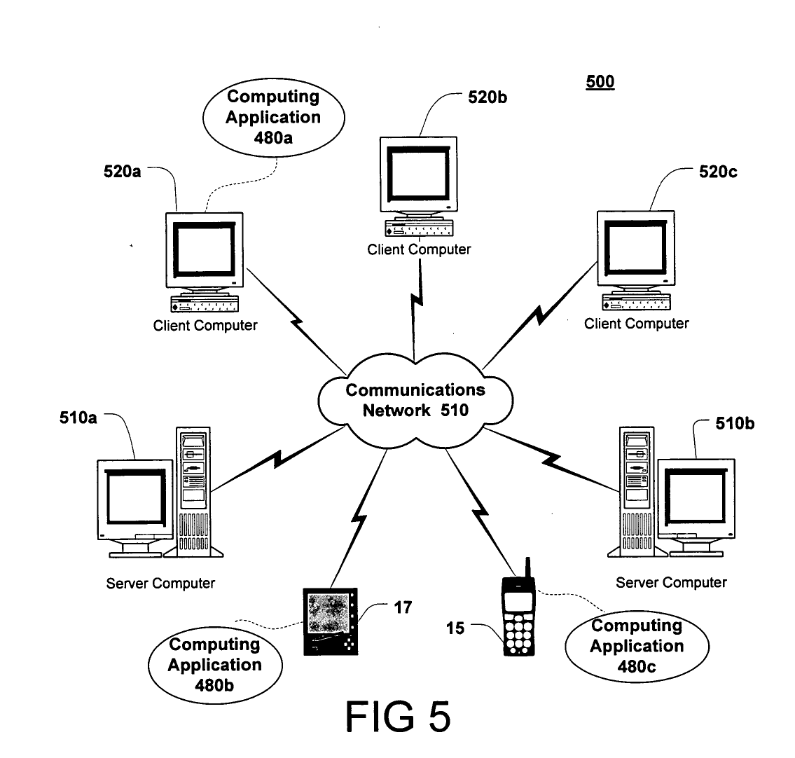

The computer described with respect to FIG. 4 can be deployed as part of a computer network. In general, the above description applies to both server computers and client computers deployed in a network environment. FIG. 5 illustrates an exemplary network environment 500, with a server computers 510a, 510b in communication with client computers 520a, 520b, 520c via a communications network 510, in which the present invention may be employed.

As shown in FIG. 5, a number of servers 510a, 510b, etc., are interconnected via a communications network 510 (which may be a LAN, WAN, intranet or the Internet) with a number of client computers 520a, 520b, 520c, or computing devices, such as, mobile phone 515 and personal digital assistant 517. In a network environment in which communications network 510 is the Internet, for example, servers 510 can be Web servers with which clients 520 communicate via any of a number of known protocols, such as, hypertext transfer protocol (HTTP) or wireless application protocol (WAP), as well as other innovative communication protocols. Each client computer 520 can be equipped with computing application 580a to gain access to servers 510. Similarly, personal digital assistant 517 can be equipped with computing application 480b and mobile phone 515 can be equipped with computing application 480c to display and receive various data.

Thus, the present invention can be utilized in a computer network environment having client computing devices for accessing and interacting with the network and a server computer for interacting with client computers. However, the systems and methods of the present invention can be implemented with a variety of network-based architectures, and thus should not be limited to the example shown.

The various systems, methods, and techniques described herein may be implemented with hardware or software or, where appropriate, with a combination of both. Thus, the methods and apparatus of the present invention, or certain aspects or portions thereof, may take the form of program code (i.e., instructions) embodied in tangible media, such as floppy diskettes, CD-ROMs, hard drives, or any other machine-readable storage medium, wherein, when the program code is loaded into and executed by a machine, such as a computer, the machine becomes an apparatus for practicing the invention. In the case of program code execution on programmable computers, the computer will generally include a processor, a storage medium readable by the processor (including volatile and non-volatile memory and/or storage elements), at least one input device, and at least one output device. One or more programs are preferably implemented in a high level procedural or object oriented programming language to communicate with a computer system. However, the program(s) can be implemented in assembly or machine language, if desired. In any case, the language may be a compiled or interpreted language, and combined with hardware implementations.

The methods and apparatus of the present invention may also be embodied in the form of program code that is transmitted over some transmission medium, such as over electrical wiring or cabling, through fiber optics, or via any other form of transmission, wherein, when the program code is received and loaded into and executed by a machine, such as an EPROM, a gate array, a programmable logic device (PLD), a client computer, or the like, the machine becomes an apparatus for practicing the invention. When implemented on a general-purpose processor, the program code combines with the processor to provide a unique apparatus that operates to perform the functionality of the present invention.

While the present invention has been described in connection with the preferred embodiments of the various figures, it is to be understood that other similar embodiments may be used or modifications and additions may be made to the described embodiments for performing the same functions of the present invention without deviating therefrom. Therefore, the present invention should not be limited to any single embodiment, but rather construed in breadth and scope in accordance with the appended claims.

What is claimed:

1. A method for updating a job assessment process, comprising:
analyzing performance appraisal data for a job with collected assessment data for the job, the performance appraisal data indicative of employee performance; and
updating the job assessment process according to the analysis.

2. The method of claim 1, wherein updating the job assessment process according to the analysis comprises requesting approval for a proposed update, and only updating the job assessment process if approval is received.

3. The method of claim 1, wherein the collected assessment data comprises answers to questions used during a job assessment process.

4. The method of claim 3, wherein analyzing performance appraisal data for the job with collected assessment data for the job comprises:
analyzing the performance appraisal data against the assessment data; and
identifying a first set of questions used during the job assessment process that have a high correlation with performance appraisal data; and
identifying a second set of questions used during the job assessment process that have a low correlation with performance appraisal data.

5. The method of claim 4, further comprising:
analyzing the performance appraisal data against employee data indicative of employee race, sex or age; and
identifying questions used by employees during the job assessment process that display bias against employee race, sex or age.

6. The method of claim 5, wherein updating the job assessment process according to the analysis further comprises removing questions identified as having a high biased impact with employee race, sex or age.

7. The method of claim 4, wherein each question in the job assessment process has an associated weight, and updating the job assessment process according to the analysis comprises increasing the weight of the first set of questions.

8. The method of claim 7, wherein updating the associated job assessment process according to the analysis comprises decreasing the weight of the second set of questions.

9. A job assessment system, comprising:
a memory device adapted to store a job assessment associated with a job; and
a processor adapted to analyze performance data for employees performing the job, and update the job assessment according to the analysis.

10. The system of claim 9, wherein the processor is further adapted to:
analyze comprehensive assessment data for employees performing the job, and update the job assessment according to the analysis

11. The system of claim 9, wherein the processor is further adapted to:
compare the performance data for each employee with collected assessment data for the employee, wherein the job assessment comprises a plurality of questions and the collected assessment data for the employee comprises answers provided by the employee subject to the assessment; and
identify questions that relate to high employee performance.

12. The system of claim 11, wherein the processor is further adapted to identify questions that do not relate to high employee performance.

13. The system of claim 11, wherein each question in the job assessment has an associated weight, and the processor is further adapted to decrease the weight of questions that do not relate to high employee performance.

14. The system of claim 11, wherein each question in the job assessment has an associated weight, and the processor is further adapted to increase the weight of questions that relate to high employee performance.

15. The system of claim 11, wherein the processor is further adapted to:
compare the collected assessment data for each employee with data for each employee indicative of the employee's race, sex, or age; and
identify questions that bias against race, sex, or age.

16. The system of claim 15, wherein the processor is further adapted to remove questions that bias against race, sex, or age.

17. A computer-readable medium with computer-executable instructions stored thereon for performing the method of:
analyzing performance appraisal data for a job with collected assessment data for the job, the performance appraisal data indicative of employee performance, the collected assessment data comprising answers to questions used during a job assessment process; and
updating the job assessment process according to the analysis.

18. The computer-readable medium of claim 17, wherein updating the job assessment process according to the analysis comprises computer-executable instructions for requesting approval for a proposed update, and only updating the job assessment process if approval is received.

19. The computer-readable medium of claim 17, wherein analyzing performance appraisal data for a job with collected assessment data for the job comprises computer-executable instructions for:
analyzing the performance appraisal data against the assessment data; and
identifying a first set of questions used during the job assessment process that have a high relationship with performance data; and
identifying a second set of questions used during the job assessment process that have a low relationship with performance data.

20. The computer-readable medium of claim 17, wherein each question in the job assessment process has an associated weight, and updating the job assessment process according to the analysis comprises computer-executable instructions for increasing the weight of questions in the first set.
